(19) United States
(12) Patent Application Publication
(10) Pub. No.: US 2006/0246191 A1
(43) Pub. Date: Nov. 2, 2006

(54) Process for the production of a jelly-containing carbonated beverage

(75) Inventor: Eng-Meng Tsai, Taipei City (TW)

Correspondence Address: Ladas & Parry LLP, 26 West 61st Street, New York, NY, 10023, US

(73) Assignee: I LAN FOODS IND. CO., LTD.

(21) Appl. No.: 11/116,067

(22) Filed: Apr. 27, 2005

(51) Int. Cl. A23L 3/10

(52) U.S. Cl. 426/407

(57) ABSTRACT

The present invention relates to a process for the production of a jelly-containing carbonated beverage, comprising the steps of: (a) providing a carbonated beverage; (b) providing a jelly; (c) sequentially filling the jelly and the carbonated beverage into a container at a temperature from about 1° C. to 10° C. under a GV value higher than about 2.0; (d) sealing the container and then subjecting the container to sterilization at a temperature from about 60° C. to 80° C. for at least about 20 minutes; (e) inverting the sealed container at least ten times; (f) cooling the container to a temperature from about 5° C. to 15° C.; and (g) inverting the sealed container at least four times.

### FIELD OF THE INVENTION

The present invention relates to a process for the production of a jelly-containing carbonated beverage.

### BACKGROUND OF THE INVENTION

Carbonated beverage is a collective term for beverages containing carbon dioxide, such as cider, coke and soda water. It has been known for centuries that carbonation of a beverage can influence the taste and sensation the beverage brings to the mouth. Consumers have for centuries made most significant distinctions between products that are uncarbonated and the same products that are carbonated. The preparation of carbonated beverages includes mixing or blending in exact proportion of flavored syrup with water and carbonating the mixture or blending under pressure with carbon dioxide in a cooled container.

Jelly or gel drinks have also been known for a long time. For example, black grass jelly drink is a traditional Chinese jelly drink. Japanese Laid-Open Patent Application No. 03-130061 discloses a method for producing a jelly-containing acidic cold beverage wherein jelly particles are suspended in a fruit juice beverage. The patent application does not teach or suggest a carbonated beverage containing jelly. Japanese Laid-Open Patent Application No. 07-284381 discloses a jelly-containing carbonated beverage containing a granular or fine cut piece-shaped gel prepared by reacting a mixture of two or more, preferably three or four, polysaccharide thickeners (carrageenan, Locust bean gum, gellan gum, xanthan gum, etc.) with a polyvalent metal salt such as calcium lactate. Japanese Laid-Open Patent Application No. 09-103271 provides a gel-containing carbonated beverage packed in a closed container, which contains gels having net structures and generates carbon dioxide gas when the beverage is chewed from the carbonated beverage contained in the net structures.

Nevertheless, there is still a need for a process of producing a jelly-containing carbonated beverage having better fluidibility and uniformly distributed CO₂.

### SUMMARY OF THE INVENTION

The present invention provides a process for the production of a jelly-containing carbonated beverage, comprising the steps of:
(a) providing a carbonated beverage;
(b) providing a jelly;
(c) sequentially filling the jelly and the carbonated beverage into a container at a temperature from about 1° C. to 10° C. under a GV value higher than about 2.0;
(d) sealing the container and then subjecting the container to sterilization at a temperature from about 60° C. to 80° C. for at least about 20 minutes;
(e) inverting the sealed container at least ten times
(f) cooling the container to a temperature from about 5° C. to 15° C.; and
(g) inverting the sealed container at least four times.

### DETAILED DESCRIPTION OF THE INVENTION

The present invention relates to a process for producing a jelly-containing carbonated beverage. The invention combines the production of jelly and that of carbonated beverage and provides an improved jelly-containing carbonated beverage having good taste, better fluidibility and uniformly distributed CO₂.

The invention relates to a process for the production of a jelly-containing carbonated beverage, comprising the steps of:
(a) providing a carbonated beverage;
(b) providing a jelly;
(c) sequentially filling the jelly and the carbonated beverage into a container at a temperature from about 1° C. to 10° C. under a GV value higher than about 2.0;
(d) sealing the container and then subjecting the container to sterilization at a temperature from about 60° C. to 80° C. for at least about 20 minutes;
(e) inverting the sealed container at least ten times;
(f) cooling the container to a temperature from about 5° C. to 15° C.; and
(g) inverting the sealed container at least four times.

The term “carbonated beverage,” as used herein, refers to any known effervescent drink that releases carbon dioxide under normal atmospheric pressure. Preferably, the carbonated beverage includes, but is not limited to, effervescent mineral water, soda, coke and cider. Preferably, the carbonated beverage is soda or cider. Different beverages, including sodas, are prepared by combining the carbonated liquid mixed with a desired syrup or taste-enhancing ingredient. Normally, carbonated beverages are made in a large apparatus such as that disclosed in U.S. Pat. No. 2,502,603.

The term “jelly”, as used herein, refers to a soft, semisolid food substance with a resilient consistency, and can be made by the setting of a liquid containing gums. According to the invention, the gum for producing the jelly is heat-reversible. Such a gum includes, but is not limited to, agar, carrageenan, Arabic gum, xanthan gum, locust bean gum, guar gum, karaya gum, tragacanth gum, konjac gum or the mixtures thereof. Preferably, the gum is selected from the group consisting of karaya gum, guar gum, agar, locust bean gum, tragacanth gum and the mixtures thereof. The jelly suitable for the invention can be made by a process such as, but not limited to, mixing gums, water and other desired ingredients under the conditions of forming a jelly, which is a technique known in the art and has been disclosed in such as “P. A. Williams and G. O. Philips, Gums and Stabilizers for Food Industry, Royal Society of Chemistry, 1st edition, Nov. 4, 2002.”

According to the invention, a jelly and a carbonated beverage are sequentially filled into a container at a temperature from about 1° C. to 10° C. under a GV value higher than about 2.0. It is not critical whether the jelly or the carbonated beverage is filled into the container first. The container suitable for the invention includes, but is not limited to, aluminum, glass, iron, tinned iron, tinned steel or plastic. Preferably, the container is selected from the group consisting of the glass bottle, aluminum can and PET bottle. Preferably, the filling step is carried out at a temperature from about 2° C. to 8° C. According to the invention, the term “GV value” denotes the coefficient of carbon dioxide adsorbtion in carbonated beverage at 20° C. Any suitable method for measuring the GV value can be used in the invention. For example, the GV value can be measured according to the method described in GB10792-89, National Standard of People Republic China. The GV value used in the process of the invention is higher than about 2.0 and determined depending on the species of the container.

According to the invention, after the filling step, the container is sealed and then sterilized at a temperature from about 60° C. to 80° C. for at least about 20 minutes. The aim of the low temperature sterilization is to thermally destroy microorganisms which cause the spoilage of the beverage or a danger to consumer health. The time and temperature required for the sterilization are influenced by several factors, including the type of microorganisms found in the beverage, the size of the container, the acidity or pH of the beverage, and the method of heating. Preferably, the low temperature sterilization is carried out at a temperature from about 65° C. to 75° C. for about 20 to 40 minutes, respectively. More preferably, the sterilization is carried out at about 70° C. for about 30 minutes.

The thermally sterilized sealed container is then performed a first inverting step. The sealed container is inverted at least ten times, preferably at least twelve times, and more preferably from twelve to sixteen times, by using inverting equipment. According to the invention, to invert the can “one time” means to turn the can 180°, i.e., upside down. Then, the container is cooled to a temperature from about 5° C. to 15° C. The cooling step can be, but is not limited to, a two-stage operation including cooling the container by water at room temperature followed by ice water. Preferably, the temperature of the ice water is lower than about 10° C. More preferably, the temperature of the ice water is from about 8° C. to 10° C. Preferably, the two-stage cooling step includes cooling the container by water for at least 5 minutes followed by ice water for at least 15 minutes. For example, the container can be cooled by water at room temperature for about 5 to 15 minutes followed by ice water for about 15 to 30 minutes. After cooling, the container is performed a second inverting step. The container is inverted at least four times, preferably from six to ten times, to provide a jelly-containing carbonated beverage without the problem of poor fluidibility for the jelly. Moreover, the beverage produced from the process of the invention provides a good tingling sensation because CO₂ gas is uniformly distributed within the jelly.

The following is a detailed description of the examples of carrying out the invention. This description is not to be taken in a limiting sense, but is made merely for the purpose of further illustrating the present inventions.

### EXAMPLE

### Example 1

### Production of the Jelly-Containing Carbonated Beverage

Production of Jelly

2 grams of carrageenan gum (Shanghai Beilian Foodstuff Co., Ltd, China; Hainan Duohuan Co., China; Danisco Co., Denmark; or FMC Co., USA), 16 grams of sugar, 978 grams of water, 3 grams of calcium lactate and appropriate amounts of flavor and coloring agent were mixed and then sterilized to form a concentrated jelly. The resulting jelly was immersed in ice water for cooling.

Production of Carbonated Beverage

Appropriate amounts of sugar were added to water at about 85° C. to form syrup and then sterilized at about 121° C. for about 30 seconds. The resulting syrup was diluted with water to Brix value of 14°. Then, desired flavor and food additives were added to the syrup. Carbon dioxide was introduced into the resulting solution to form a carbonated beverage.

Production of the Jelly-Containing Carbonated Beverage

Sequentially filling the jelly and the carbonated beverage into an aluminum can was carried out at a temperature of 4.0±1.0° C. under a GV value of 2.5±0.2. After the filling step, the can was sealed and then sterilized at a temperature of 70±1.0° C. for 30±1 minutes. The sterilized sealed can was then inverted twelve times. Subsequently, the can was cooled by water at room temperature for about 11 minutes and then ice water at a temperature from about 8° C. to 10° C. for about 22 minutes. The cooled can was inverted three times to obtain the product of jelly-containing carbonated beverage.

What is claimed is:

1. A process for the production of a jelly-containing carbonated beverage, comprising the steps of:
(a) providing a carbonated beverage;
(b) providing a jelly;
(c) sequentially filling the jelly and the carbonated beverage into a container at a temperature from about 1° C. to 10° C. under a GV value higher than about 2.0;
(d) sealing the container and then subjecting the container to sterilization at a temperature from about 60° C. to 80° C. for at least about 20 minutes;
(e) inverting the sealed container at least ten times;
(f) cooling the container to a temperature from about 5° C. to 15° C.; and
(g) inverting the sealed container at least four times.

2. The process according to claim 1, wherein the carbonated beverage is selected from the group consisting of effervescent mineral water, soda, coke and cider.

3. The process according to claim 1, wherein the carbonated beverage is selected from the group consisting of soda and cider.

4. The process according to claim 1, wherein the jelly is made from the material selected from the group consisting of agar, carrageenan, Arabic gum, xanthan gum, locust bean gum, guar gum, karaya gum, tragacanth gum, konjac gum and the mixtures thereof.

5. The process according to claim 1, wherein the jelly is made from the material selected from the group consisting of karaya gum, guar gum, alginate, locust bean gum, tragacanth gum and the mixtures thereof.

6. The process according to claim 1, wherein the container is selected from the group consisting of aluminum, glass, iron, tinned iron, tinned steel and plastic.

7. The process according to claim 1, wherein the container is selected from the group consisting of the glass bottle, aluminum can and PET bottle.

8. The process according to claim 1, wherein the filling step is carried out at a temperature from 2° C. to 8° C.

9. The process according to claim 1, wherein the sterilization is carried out at a temperature from about 65° C. to about 75° C. for about 20 to about 40 minutes.

10. The process according to claim 1, wherein the sterilization is carried out at about 70° C. for about 30 minutes.

11. The process according to claim 1, wherein the cooling step (f) comprises cooling the container by water at room temperature followed by ice water.

12. The process according to claim 11, wherein the ice water is at a temperature lower than about 10° C.

13. The process according to claim 11, wherein the ice water is at a temperature ranging from about 8° C. to 10° C.

14. The process according to claim 11, wherein the ice water cooling is carried out for at least 15 minutes.

15. The process according to claim 11, wherein the cooling step comprises cooling the container by water for about 5 to 15 minutes followed by ice water for about 15 to 30 minutes.
